(19) United States
(12) Patent Application Publication
(10) Pub. No.: US 2013/0141426 A1
(43) Pub. Date: Jun. 6, 2013

(54) THREE-DIMENSIONAL IMAGING

(71) Applicant: Lee Atkinson, Cypress, TX (US)

(72) Inventor: Lee Atkinson, Cypress, TX (US)

(21) Appl. No.: 13/581,892

(22) PCT Filed: Jul. 19, 2010
(86) PCT No.: PCT/US10/42388

§ 371 Date: Aug. 30, 2012

(51) Int. Cl. G06T 15/00

(52) U.S. Cl. CPC G06T 15/005
USPC 345/419

(57) ABSTRACT

Methods and means related to three-dimensional imaging are provided. A serial data stream formatted as respective frames is provided to an electronic display. The data stream is parsed and an initial portion of each frame is buffered. The buffered data is used with rear-time data to write pixels in two or more distinct regions of the display contemporaneously. Shutter glasses are synchronized to left and right images on the display. The extended image presentation periods result in a favorable 3D viewing experience by the user.

### BACKGROUND

Electronic displays are used for providing three-dimensional (3D) imagery that is viewed by way of special glasses worn by a user. Left and right shutters of the viewing glasses are individually opened and closed in accordance with left and right images depicted on the display. Flat-panel electronic displays and other devices can thus be used for presenting 3D videos and still images.

However, 3D images are generally darker and of unsatisfactory viewing quality when compared to two-dimensional imaging, especially high-definition television and video. The present teachings are directed to the foregoing concerns.

### BRIEF DESCRIPTION OF THE DRAWINGS

The present embodiments will now be described, by way of example, with reference to the accompanying drawings, in which:

FIG. 1 depicts a diagrammatic view of a system according to one embodiment;

FIG. 2 depicts a schematic view of an operation according to one embodiment;

FIG. 3 is a signal timing diagram depicting signals according to one embodiment;

FIG. 4 is a flow diagram depicting a method according to another embodiment;

FIG. 5 is a block diagram depicting a system according to still another embodiment;

FIG. 6 depicts a schematic view of an operation according to one embodiment;

FIG. 7 depicts a schematic view of an operation according to another embodiment.

### DETAILED DESCRIPTION

### Introduction

Methods and means related to three-dimensional imaging on electronic displays are provided. A serial data stream is formatted as respective frames and is provided to an electronic display. The data stream is parsed and an initial portion of each frame is buffered within storage of the display. The buffered data is then used with data received in real-time so as to write pixels in two or more distinct regions of the electronic display contemporaneously. Such simultaneous writing to plural display regions results in faster presentation of the image (or frame) on the display screen. Shutter glasses, worn by a user, are synchronized to the respective left and right stereoscopic images as they are sequentially presented on the display. The extended presentation periods thus provided result in brighter images and a favorable 3D viewing experience by the user.

In one embodiment, an apparatus is configured to receive a serial data stream formatted as a sequence of frames. Each of the frames represents an image of a three-dimensional presentation defined by left and right images. The apparatus is also configured to buffer a first portion of each frame. The apparatus is further configured to use the buffered first portion of each frame with a second portion of each frame to contemporaneously write pixels in at least two distinct regions of an electronic display so as to present each image in the sequence.

In another embodiment, a method is performed by a machine. The method includes contemporaneously writing pixels in two or more distinct regions of an electronic display, so as to present either a left image or right image of a three-dimensional presentation.

### First Illustrative System

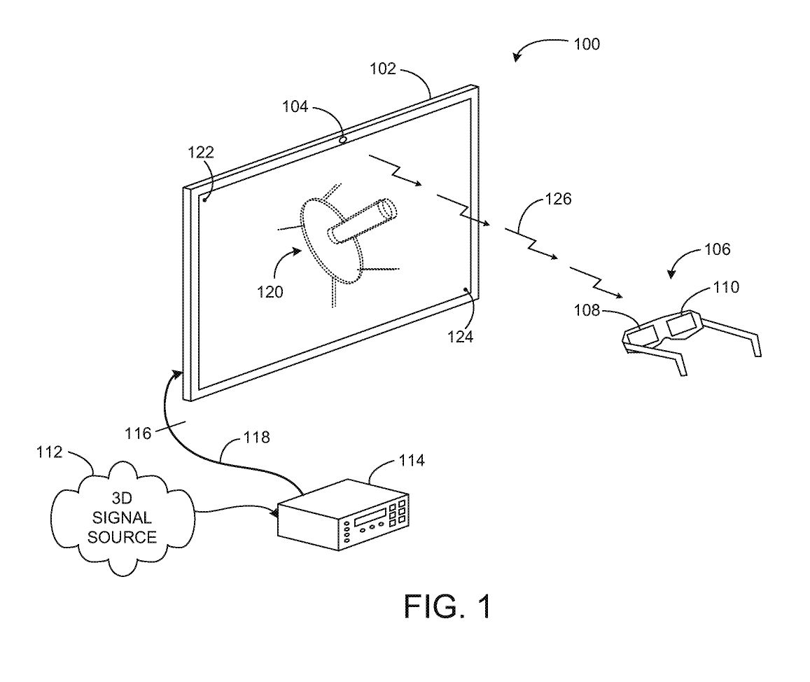

Reference is now directed to FIG. 1, which depicts a diagrammatic view of a system 100. The system 100 is illustrative and non-limiting in nature. Thus, other systems can be configured and/or operated in accordance with the present teachings.

The system 100 includes a flat-panel electronic display (display) 102. The display 102 can be defined by any such device that includes resources according to the present teachings. In one embodiment, the display 102 is defined by a high-definition liquid crystal display (LCD) type of video monitor. Other suitable types of display can also be used in accordance with the present teachings.

The display 102 includes a wireless signal emitter 104. The emitter 104 can be defined by a light emitter such as a light-emitting diode. Such a light-emitting diode (LED) 104 can operate in either within or outside of the visible spectrum. Other types of wireless or optical signal emitter 104 can also be used. The emitter 104 is controlled as described hereinafter.

The system 100 also includes a pair of three-dimensional viewing glasses or goggles 106. The glasses 106 include a left shutter 108 and a right shutter 110 that are independently open-able and closable. In one embodiment, the respective shutters 108 and 110 are defined by liquid crystal apertures or “windows” that can be rapidly and independently toggled between transparent (i.e., open) and opaque (i.e., closed) conditions.

The glasses 106 further include on-board circuitry and a power source (not shown, respectively) as required to perform normal operations of the respective shutters 108 and 110. The glasses 106 operate as known to one having ordinary skill in the three-dimensional viewing arts,and further elaboration is not required for an understanding of the present teachings except as noted below.

The system 100 also includes a source of three-dimensional (3D) signals 112. The source 112 can be variously defined in accordance with the present teachings. Non-limiting examples of the source 112 include the Internet, a satellite television signal provider, a cable television signal provider, etc. The source 112 provides digital data or signals corresponding to (or representing) 3D images or video content.

The system 100 also includes a 3D capable device 114. The device 114 can be variously defined in accordance with the present teachings. Non-limiting examples of the device 114 include an optical disc reader or player, a magnetic media reader or player, a satellite or cable signal receiver, etc. Other types of receiving or media reader or playback devices can also be used.

The device 114 is generally configured to provide digital signals or data 116 representative of 3D image or video content to the display 102 by way of a suitable cabling assembly 118. Non-limiting examples of such a cabling assembly 118 include a high-definition multimedia interface (HDMI) cable, a DisplayPort cable, etc. HDMI is a registered mark owned by HDMI Licensing, LLC, Sunnyvale, Calif., USA. DisplayPort was a registered mark (now dead) that was owned by Video Electronics Standards Association (VESA), Newark, Calif., USA. The particular type or identity of the device 114 is not germane to the invention, and further elaboration is not needed for purposes of understanding the present teachings.

The digital signals 116 are provided as a serial data feed to the display 102. That is, the data representative of 3D imaging 120 is provided in a time-sequential order corresponding to a raster-scan schema. Under such a schema, data is sent as a sequence of alternating left, right, left, right (etc.) frames. Each frame is defined by serial data 116 transmitted by the device 114 in time order beginning with the upper-most left pixel 122 and proceeding across a top row, then a next lower row, and so on, ending in the lower-most right pixel 124.

Once an entire left (or right) frame has been written to the pixels of the display 102, the corresponding left (or right) shutter 108 (or 110) of the glasses 106 is signaled to open (become transparent) by way of wireless signals 126. The displayed frame is then visible to the user of the glasses 106. The period of time that the frame is usefully present on the display 102 is referred to as a “valid frame” or “presentation” period. Either the shutter 108 or the shutter 110 is open only during a corresponding valid frame period, and both are closed otherwise.

The display 102, according to the present teachings, is configured to receive the data 116 from the device 114 and to identify each respective frame. The display 102 is further configured to buffer an initial portion of each received frame. The buffered initial portion of each frame is then used to write or drive the upper region of the display 102 contemporaneous with the writing of the lower region of the display 102 using the remaining portion of the received frame.

Thus, the upper and lower regions of the display 102 are written to as two simultaneous operations and the overall image is written (or drawn) in half of the time required to write the display as one top-to-bottom operation. This results in an appreciably longer presentation time per frame, and a clearer and brighter image is perceived by the user of the glasses 106. Further elaboration on operation and devices is provided below.

### First Illustrative Operation

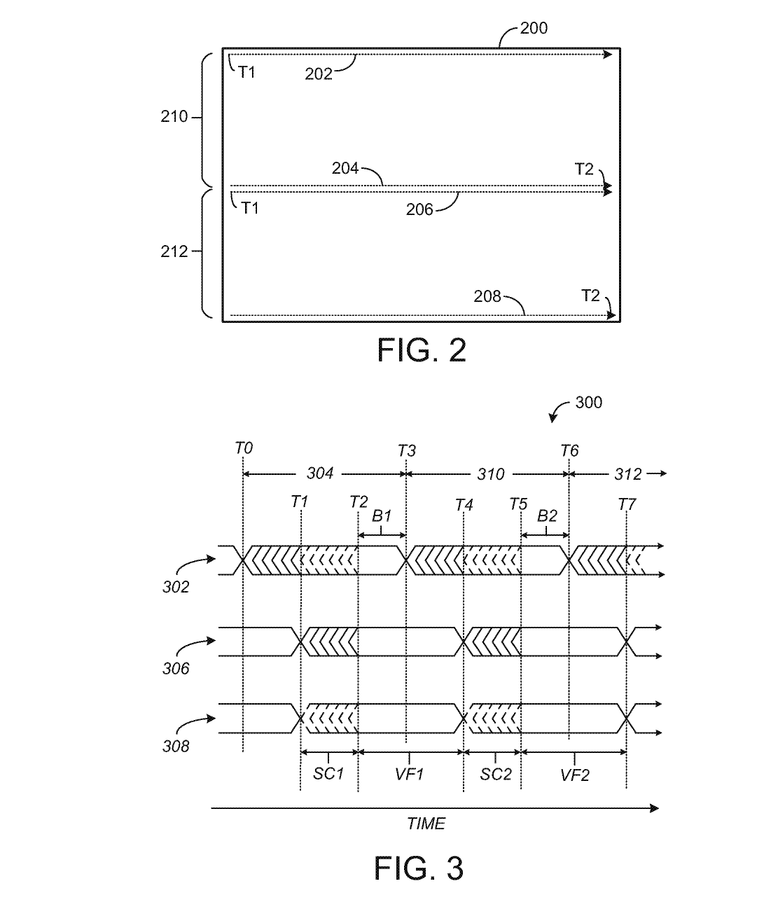

Attention is now directed to FIG. 2, which depicts a schematic view of an operation of a display 200 in accordance with another embodiment of the present teachings. The operation depicted by FIG. 2 is illustrative and non-limiting in nature. As such, other operations performed by way of other devices are contemplated by the present teachings.

The display 200 is defined by an LCD flat-panel display. The display 200 is further defined by an array of distinct pixels. The pixels of the display 200 are arranged to define respective rows, including atop pixel row 202, two adjacent intermediate pixel rows 204 and 206, and a bottom pixel row 208. The pixels of the display 200 are arranged to define other pixel rows not shown in the interest of clarity.

The display 200 can be operated in accordance with conventional raster scanning so that normal or high-definition video signals can be displayed. In one of the immediate foregoing cases, the pixels of the display 200 are written to or driven in a sequential order, beginning with the top pixel row 202 and progressing from left to right as shown by the corresponding arrowhead. The next lower pixel row is then written in order, and so on, until all rows of pixels—including pixel rows 202, 204, 206 and 208—are written to, thus defining one image. After a brief delay, writing pixels of the next frame begins with pixel row 202, and so on.

However, according to the present teachings, frames of 3D images and video can be presented as follows: Data representing 3D imaging is received and an initial portion of a present frame is buffered in memory or other suitable storage. This initial data portion corresponds to pixel rows 202 through 204 and those pixel rows in between (not shown). Thereafter, received data within the present frame corresponds to pixel rows 206 through 208 and those pixel rows in between (not shown).

Data corresponding to row 206 begins to arrive at a time “T1” and is used to write the pixels of row 206 and the pixel rows there following. Contemporaneously at the time “T1”, the buffered data is used to write the pixels of row 202. Thus, pixels rows 202 and 206 are written (or driven) contemporaneously using buffered and real-time data, respectively. This process continues with the writing of other pixel rows until the last pixels of rows 204 and 208, respectively, are simultaneously written at a time “T2”.

In the foregoing way, 3D data is written to the display 200 by treating the display as an upper region 210 and a lower region 212. The pixels of the display 200 are written as upper and lower regions at the same time on a per-frame basis. This allows for the frame to be written in half the time required otherwise and provides for a significantly extended presentation period.

### First Illustrative Signals

FIG. 3 is a signal timing diagram 300 depicting signals according to another embodiment of the present teachings. The diagram 300 is illustrative and non-limiting in nature. Thus, other signaling schemas and related operations can also be performed in accordance with the present teachings.

The diagram 300 includes a serial data stream 302. The data stream 302 corresponds to (represents or encodes) 3D imaging that can be presented on an electronic display (e.g., 102, 200, etc.) or another suitable device. The data stream 302 is formatted as a sequence of alternating left-right-left-right images.

The data stream 302 includes a left-image frame (or frame period) 304 that extends from a time “T0” to a time “T3”. Data corresponding to an upper region of the left-image frame 304 is provided from time “T0” to a time “T1”. Data corresponding to a lower region of the left-image frame 304 is provided from time “T1”” to time “T2”. A brief delay or blanking period “B1” is provided from time “T2” to time “T3”.

The diagram 300 also includes an upper data stream or portion 306 and a lower data stream or portion 308. The respective data portions 306 and 308 are selected or extracted from the serial data stream 302. Specifically, the upper data portion 306 is that data corresponding to the upper region (e.g., 210) of respective images. In turn, the lower data portion 308 is that data corresponding to the lower region (e.g., 212) of respective images. The data portion 306 is buffered or stored in memory as it initially arrives via data stream 302 and is then used simultaneously with the data portion 308 as it arrives in real time. Upper and lower regions of a display (e.g., 200) are thus simultaneously written or driven by way of the buffered data portion 306 and the real-time data portion 308.

The data steam 302 includes the upper data portion 306 of left-image frame 304 from time “T0” to time “T1”. The data stream 302 also includes the lower data portion 308 of the left-image frame 304 from time “T1” to “T2”. The period from time “T1” to time “T2” is referred to as time period “SC1”—that is, “shutters closed 1”. The display (e.g., 102) is being written as simultaneous upper and lower regions during time period “SC1”.

The data stream 302 also includes a right-image frame (or frame period) 310 that extends from time “T3” to a time “T6”. Data corresponding to an upper portion of the right-image frame 310 is provided from time “T3” to a time “T4”. Data corresponding to a lower portion of the right-image frame 310 is provided from time “T4’ to time “T5”. A brief delay or blanking period “B2” is provided from time “T5” to time “T6”.

The data stream 302 of right-image frame 310 is parsed so as to buffer upper portion 306 from time “T3” to time “T4”. The buffered upper portion 306 is then used contemporaneously with the lower portion 308 as it arrives in real time so to write the right-image frame 310 to the display (e.g., 102) from time “T4” to time “T5”—also referred to as period “SC2”. The data stream 302 includes data for the next left-image frame beginning at time “T6” and extending beyond a time “T7”. The data stream 302 continues to convey images i.e., frames) in a left-right-left-right time sequence so as to provide a 3D video segment, provide a 3D still image for a period of time, etc.

During illustrative and non-limiting operations according to the present teachings, the respective data signals of diagram 300 are used as follows: buffered data portion 306 and real-time data portion 308 are used to write left-image frame 304 to a display 102 during time period “SC1”. The display 102 provides a wireless signal 126 to glasses 106 causing both the left shutter 108 and the right shutter 110 to remain closed (opaque) during the time period “SC1”.

Once the entire left-image frame 304 is written to the display, the display 102 signals the glasses 106 to open the left shutter 108 during the entirety of a time period “VF1”—that is, “valid frame 1”. It is noted that the time period VF1 extends from time “T2 to time “T4”, and is significantly greater than time period “B1”. In one embodiment, the period VF1 is greater than fifty percent of the left-image frame period 304. Other time period ratios corresponding to other embodiments are also possible. The upper portion 306 of right-image frame 310 is buffered from time “T3” to time “T4”—that later portion of period VF1—during which the left shutter 108 of glasses 106 remains open.

Thereafter, buffered data portion 306 and rear-time data portion 308 are used to write right-image frame 310 to the display 102 during time period “SC2”. The display 102 provides a wireless signal 126 to glasses 106 causing both left and right shutters 108 and 110 to remain closed (opaque) during the time period “SC2”.

The display 102 then signals the glasses 106 to open the right shutter 110 during the entirety of a time period “VF2”. It is noted that the time period VF2 extends from time “T5” to time “T7”, and is significantly greater than time period “B2”. In one embodiment, the time period VF2 is greater than fifty percent of the right-image frame period 310. Other time period ratios corresponding to other embodiments are also possible. It is also noted that the upper portion 306 of a next-in-time left-image frame 312 is buffered from time “T6” to time “T7”. The left-right-left-right sequence of data reception, data buffering, display writing and user glasses activation continues as described above throughout a 3D video segment, etc.

In one embodiment, the data stream 302 is parsed such that the upper data portion 306 and lower data portion 308 are of about equal quantities—that is, a half-and-half division of the data stream 302 corresponding to two equal upper and lower regions of an electronic display. However, it is to be understood that other data parsing ratios can also be used in accordance with the present teachings.

For non-limiting example, the present teachings contemplate a schema in which a 3D serial data stream is parsed such that thirty percent of the data is buffered (upper display region) and seventy percent of the data is used real time (lower display region). Other data parsing ratios can also be used.

### First Illustrative Method

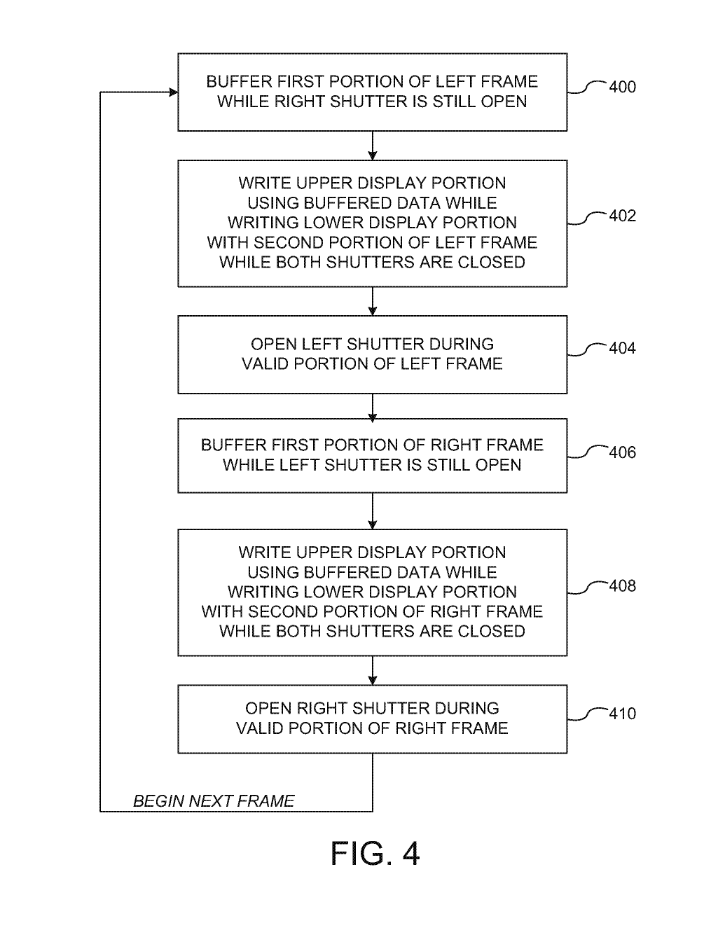

FIG. 4 is a flow diagram depicting a method according to one embodiment of the present teachings. The method of FIG. 4 includes particular operations and order of execution. However, other methods including other operations, omitting one or more of the depicted operations, and/or proceeding in other orders of execution can also be used according to the present teachings. Thus, the method of FIG. 4 is illustrative and non-limiting in nature. Reference is also made to FIGS. 1 and 3 in the interest of understanding the method of FIG. 4.

At 400, a first portion of a left-image frame is buffered while a right shutter of user viewing goggles remains open. For purposes of non-limiting example, a data stream 302 is being conveyed to a 3D-capable display 102. At present, a left-image frame 304 is being conveyed and a data portion 306 is buffered to memory or other storage within the display 102. The portion being buffered corresponds to an upper region of the display 102. The right shutter 110 of user glasses 106 is signaled to remain open during this time.

At 402, the buffered data is used to write an upper display region while received data is used in real-time to write a lower display region. The user glasses are signaled to keep both left and right shutters closed during this time. For purposes of the present example, it is assumed that a second portion 308 of the left-image frame 304 is used to write a lower region, while the data buffered at 400 above is used to write an upper region, of the display 102. Simultaneously, the user glasses 106 are signaled to keep both shutters 108 and 110 closed during this time period.

At 404, the left shutter of the user viewing glasses is signaled to open during a valid left-frame time period. For purposes of the present example, the left-image frame 304 has been fully written to the display 102 and the left shutter 108 is signaled to be open by way of wireless signaling 126. This open condition of the shutter 108 is maintained during a presentation period VF1.

At 406, a first portion of a right-image frame is buffered while the left shutter of the user viewing goggles remains open. For purposes of the ongoing example, a right-image frame 310 is being communicated and a data portion 306 is buffered to memory or other storage within the display 102. The left shutter 108 of user glasses 106 is signaled to remain open during this time.

At 408, the buffered data is used to write an upper display region while received data is used in real-time to write a lower display region. The user glasses are signaled to keep both left and right shutters closed during this time. For purposes of the ongoing example, it is assumed that a second portion 308 of the right-image frame 310 is used to write a lower region, while the data buffered at 406 above is used to write an upper region, of the display 102. Simultaneously, the user glasses 106 are signaled to keep both shutters 108 and 110 closed during this time period.

At 410, the right shutter of the user viewing glasses is signaled to open during a valid right-frame time period. For purposes of the present example, the right-image frame 310 has been fully written to the display 102 and the right shutter 110 is signaled to be open by way of wireless signaling 126. This open condition of the right shutter 110 is maintained during a presentation period VF2. The method then returns to step 400 above, at the beginning of the next left-image frame 312. This method is continued in an ongoing manner throughout a 3D (i.e., stereoscopic) video or still image presentation.

### Second Illustrative System

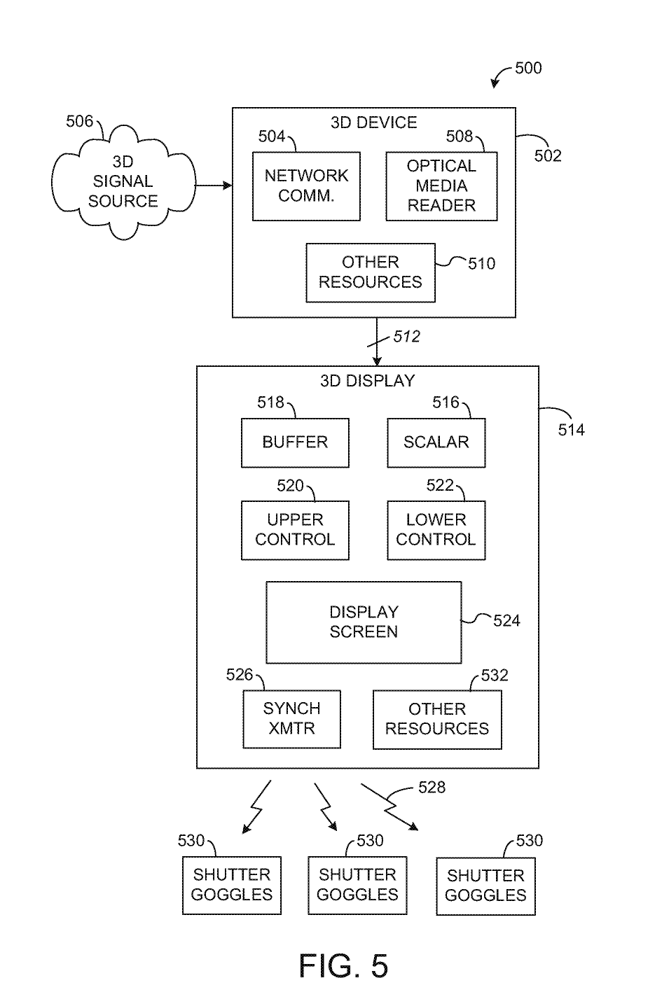

Attention is now turned to FIG. 5, which depicts block diagram of a system 500 in accordance with another embodiment. The system 500 is illustrative and non-limiting. Thus, other systems and devices can be defined and used in accordance with the present teachings.

The system 500 includes a 3D capable device 502. The device 502 includes network communications resources or circuitry 504 configured to receive digital data or signals from a source 506. The data received from the 3D source 506 corresponds to 3D images, videos, corresponding audio content, etc. The device 502 also includes an optical media reader 508 configured to read or access data corresponding to 3D content encoded on an optical storage media,

The device 502 also includes other resources 510 as desired or required for normal operations of the device 502. Non-limiting examples of such other resources include one or more microprocessors, a power supply, a user interface, remote-control interface circuitry, etc. Other resources can also be present.

One having ordinary skill in the electronic and related arts can appreciate that the device 502 can be variously defined and configured, and that further elaboration is not required for purposes of understanding the present teachings. The device 502 is generally configured to provide a serial data stream 512 corresponding to 3D content to be presented via an associated electronic display.

The system 500 also includes a 3D capable display 514. The display 514 is coupled to receive the serial data stream 512 from the device 502. The display 514 includes a scalar 516. The scalar includes electronic circuitry or other resources so as to adapt or “scale” the resolution of the received data stream 512 to the resolution of the display 514. One having ordinary skill in the electronic display and related arts is familiar with scalars and scaling operations, and further elaboration is not required for understanding the present teachings.

The display 514 also includes a buffer 518 that is configured to store at least some of the data content received by way of the data stream 512. The buffer 518 is configured to store an initial data portion of each frame either directly from the serial data stream 512 or as provided by the scalar 516. The data stored within the buffer 518 is then read or “dumped” during writing of the data to a display.

The display 514 also includes an upper control or controller 520 and a lower control or controller 522. The upper control 520 is configured to read or access data stored within the buffer 518 and to use that data to write pixels in an upper region of a display screen 524. In turn, the lower control 522 is configured to extract real-time data either directly from the data stream 512 or as provided by the scalar 516 and to use that data to write pixels in a lower region of the display screen 524. In another embodiment, the upper and lower controls 520 and 522 are combined as or effectively replaced by a single controller (not shown).

The upper control 520 and the lower control 522 can include or be defined by any suitable circuitry or components. For non-limiting example, each control 520 and 522 (respectively) can include or be defined by a microprocessor, a microcontroller, one or more application-specific integrated circuits (ASIC), a state machine, etc. Any suitable electronic entities and resources can be used to define and provide the upper and lower controls 520 and 522.

The display 514 also includes a display screen 524 as introduced above. The display screen 524 is an LCD type defined by an array of addressable pixels. The pixels are arranged to define successive rows from a top or upper edge to a bottom or lower region. Other suitable types of display screen comprised of individually addressable and controllable pixels can also be used. The display screen 524 is configured to be written to or driven by the upper control 520 and the lower control 522, respectively, such that upper and lower regions can be contemporaneously written in accordance with the present teachings.

The display 514 also includes a synch transmitter 526 configured to provide wireless signals 528 to shutter or user goggles 530. The synch transmitter thus provides signals 528 causing the left and right shutters of the goggles 530 to independently open and close in accordance with an image presented on the display screen 524. In one embodiment, the synch transmitter 526 is configured to provide the wireless signals 528 by way of an infra-red LED. Other embodiments can also be used.

The display 514 further includes other resources 532 as desired or required for normal operation. Non-limiting examples of such resources includes a power supply, a user interface, a remote-control interface, a signal tuner or decoder, etc. In one or more embodiments, the display 514 includes circuitry or other resources 532 directed to automatically select an operating mode such as, for non-limiting example, a conventional raster scan mode, a stereoscopic or 3D mode according to the present teachings, etc. Such a mode selection can be based upon detection of signal format or content, other signals peripheral to the image data, etc. One having ordinary skill in the electronic and related arts can appreciate such various other resources 532 and further elaboration is not needed for an understanding of the present teachings,

Typical, normal non-limiting operations of the system 500 are as follows; the 3D capable device 502 reads data from an optical storage media by way of the reader 508. The data corresponds to a 3D video segment or movie with associated audio information. A serial data stream 512 corresponding to the 3D video is provided to a 3D capable display 514. The serial data stream 512 is formatted in a left-right-left-right image (or frame) sequence generally as described previously herein,

The display 514 receives the data stream 512 and scales the image resolution as needed by way of the scalar 516. An initial portion of the data from each frame is temporarily stored in the buffer 518 until it is used to write pixels within an upper region of the display screen 524. Contemporaneous with such an upper-region write operation is the writing of a lower region of the display screen 524. Such upper-region and lower-region pixel writing operations are performed by way of the upper control 520 and lower control 522, respectively. The synch transmitter 526 signals the goggles 530 to keep both left and right shutters closed during this image writing operation.

When an image (left or right) has been fully presented on the display screen 524, the synch transmitter 526 signals the goggles 530 to open the appropriate shutter (left or right) by way of wireless signals 528. This open condition is maintained during a valid frame period. Serial data 512 continues to be provided by the device 502 and an initial portion of the next frame is scaled (as needed) and buffered by the display 514 until the next pixel writing operation.

### Second Illustrative Operation

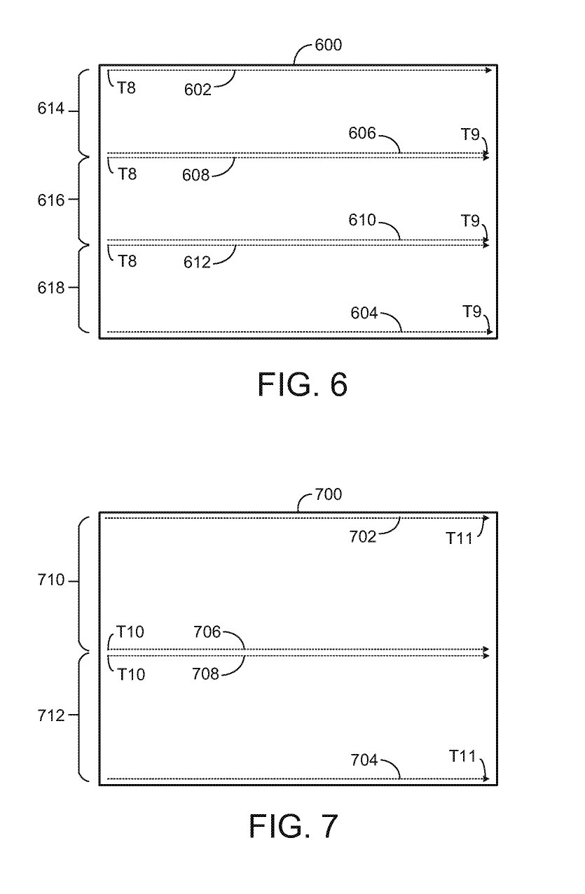

Attention is now directed to FIG. 6, which depicts a schematic view of an operation of a display 600 in accordance with another embodiment of the present teachings. The operation depicted by FIG. 6 is illustrative and non-limiting in nature. As such, other operations performed by way of other devices are contemplated by the present teachings. The display 600 includes buffer or storage media, display control, or other resources (not shown, respectively) that are analogous to those described above in accordance with the present teachings.

The display 600 is defined by an LCD flat-panel display, further defined by an array of distinct pixels. The pixels of the display 600 are arranged as respective rows, including a top pixel row 602, a bottom pixel row 604, and respective intermediate pixel rows 606, 608, 610 and 612.

It is noted that the pixel rows 602 and 606 define top and bottom pixel rows, respectively, of an upper display region 614. In turn, pixel rows 608 and 610 define top and bottom pixel rows, respectively, of an intermediate display region 616. Furthermore, pixel rows 612 and 604 define top and bottom pixel rows, respectively, of a lower display region 618. It is to be understood that the display 600 includes other pixel rows within the upper display region 614 and the intermediate display region 616 and the lower display region 618, respectively, that are omitted in the interest of clarity.

The display 600 can be operated in accordance with conventional raster scanning so that normal, high-definition or high-resolution video signals can be displayed. The display 600 can be configured to automatically select an operating mode (i.e., conventional raster scan mode, stereoscopic or 3D mode, etc.) based upon detection of signal format or content, etc.

However, according to the present teachings, frames of 3D images and video can be presented as follows: Data representing 3D imaging is received and an initial portion of a present frame is buffered in memory or other suitable storage. This initial data portion corresponds to pixel rows 602, 606, 608 and 610, and those pixel rows (not shown) that lie in between. That is, the buffered portion of the present frame corresponds to pixel rows of the upper and intermediate display regions 614 and 616, respectively. Thereafter, data within the present frame received in real-time corresponds to pixel rows 612 through 604 and those pixel rows in between (not shown).

Data corresponding to pixel row 612 begins to arrive at a time “T8” and is used to write pixel row 612 and the pixel rows there following. Contemporaneously at the time “T8”, the buffered data is used to write of pixel row 602 and pixel row 608. Thus, pixels rows 602, 608 and 612 are written (or driven) contemporaneously using buffered and rear-time data, respectively. This process continues with the writing of other pixel rows until the end of pixel rows 606, 610 and 604, respectively, are simultaneously written at a time “T9”.

In the foregoing way, 3D data is written to the display 600 by treating the display as respective upper, intermediate and lower regions. The pixels of the display 600 are written as three distinct regions at the same time on a per-frame basis. This allows for the frame to be written in less time than is required otherwise and provides for a significantly extended presentation period.

The embodiment of FIG. 6 is directed to simultaneously writing pixels in three distinct regions of a display. It is to be understood that the present teachings contemplate various embodiments that simultaneously write pixels in any suitable number of distinct display regions (e.g., two, three, four, five, etc.).

### Third Illustrative Operation

Attention is now turned to FIG. 7, which depicts a schematic view of an operation of a display 700 in accordance with yet another embodiment of the present teachings. The operation depicted by FIG. 7 is illustrative and non-limiting in nature. As such, other operations performed by way of other devices are contemplated by the present teachings. The display 700 includes buffer or storage media, display control, or other resources (not shown, respectively) that are analogous to those described above in accordance with the present teachings.

The display 700 is defined by an LCD fiat-panel display, further defined by an array of distinct pixels. The pixels of the display 700 are arranged as respective pixel rows, including a top pixel row 702, a bottom pixel row 704, and respective intermediate pixel rows 706 and 708. The display 700 can be configured to automatically select an operating mode (i.e., conventional raster scan mode, stereoscopic or 3D mode, etc.) based upon detection of signal format or content, etc.

It is noted that the pixel rows 702 and 706 define top and bottom pixel rows, respectively, of an upper display region 710. In turn, pixel rows 708 and 704 define top and bottom pixel rows, respectively, of a lower display region 712. It is to be understood that the display 700 includes other pixel rows within the upper display region 710 and the lower display region 712, respectively, that are omitted in the interest of clarity.

The display 700 can be operated in accordance with conventional raster scanning so that normal, high-definition or high-resolution video signals can be displayed. However, according to the present teachings, frames of 3D images and video can be presented as follows: Data representing 3D imaging is received and an initial portion of a present frame is buffered in memory or other suitable storage. This initial data portion corresponds to pixel rows 702 and 706 and those pixel rows (not shown) that lie in between. That is, the buffered portion of the present frame corresponds to pixel rows of the upper display region 710. Thereafter, data within the present frame received in real-time corresponds to pixel rows 708 and 704 and those pixel rows in between (not shown).

Data corresponding to pixel row 708 begins to arrive at a time “T10” and is used to write pixel row 708 and the pixel rows there following. Contemporaneously at the time “T10”, the buffered data is used to write pixel row 706. Thus, pixels rows 706 and 708 are written (or driven) contemporaneously using buffered and real-time data, respectively. This process continues with the writing of other pixel rows until the end of pixel rows 702 and 704, respectively, are simultaneously ten at a time “T11”.

In the foregoing way, 3D data is written to the display 700 by treating the display as respective upper and lower regions. The pixels are thus written as two distinct regions starting at a mid-region of the display 700 and working outward toward the top and bottom pixel rows 702 and 704, respectively. This allows for the frame to be written in less time than is required otherwise and provides for a brighter and significantly extended presentation period.

In general, and without limitation, the present teachings contemplate any number of devices, systems and methods by which 3D images—still or moving—are presented by way of electronic displays. Serial data representing (or encoding) 3D images are parsed and a portion of the data is buffered. The buffered data and other data receive in real-time is used to simultaneously (or contemporaneously) write (or drive) pixel rows in two or more regions of an electronic display. Valid image presentation time in accordance with the present teachings increased relative to known techniques, resulting in improved image brightness and an enhanced user experience.

In general, the foregoing description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

What is claimed is:

1. An apparatus, configured to:
receive a serial data stream formatted as a sequence of frames, each frame representing an image of a three-dimensional presentation defined by left and right images;
buffer a first portion of each frame; and
use the buffered first portion of each frame with a second portion of each frame to contemporaneously write pixels in at least two distinct regions of an electronic display so as to present each image in the sequence.

2. The apparatus according to claim 1, the apparatus including electronically accessible storage media configured to buffer the first portion of each frame.

3. The apparatus according to claim 1, the electronic display being a part of the apparatus, the apparatus further configured to automatically invoke a three-dimensional operating mode for the display in accordance with content or format of the serial data stream.

4. The apparatus according to claim 1, the electronic display defined by a plurality of individually addressable pixels arranged as an array.

5. The apparatus according to claim 1 further configured to present each image of the three-dimensional presentation in its respective entirety on the electronic display for a presentation period.

6. The apparatus according to claim 5, the serial data stream further formatted such that each frame is defined by a frame period, each presentation period being greater than thirty percent of the corresponding frame period.

7. The apparatus according to claim 1 further configured to provide a synchronization signal in accordance with a presentation of a left image or a right image on the electronic display.

8. The apparatus according to claim 7, the synchronization signal provided by way of a wireless signal emitter, or a light-emitting device of the apparatus.

9. The apparatus according to claim 1, the apparatus including a controller configured to use the buffered first portion of each frame to write pixels in an upper region of the electronic display.

10. The apparatus according to claim 1 further configured to receive the serial data stream from a distinct entity, the distinct entity including at least an Internet communications receiver, a wireless communications receiver, a satellite communications receiver, a cable communications receiver, an optical media player, or a magnetic media player.

11. The apparatus according to claim 1, the apparatus including a scalar configured to scale a resolution of the received serial data stream in accordance with a resolution of the electronic display.

12. A method performed by a machine, comprising:
contemporaneously writing pixels in two or more distinct regions of an electronic display so as to present either a left image or right image of a three-dimensional presentation.

13. The method according to claim 12 further comprising:
buffering a portion of a frame of serial data, the buffering performed by way of an electronic storage media; and
using the buffered portion of the frame with a real-time portion of the frame to perform the contemporaneously writing pixels in the two or more distinct regions of the electronic display.

14. The method according to claim 12 further comprising providing a free-space synchronization signal formatted to be received by shutter glasses in accordance with a valid presentation of a left image or a right image on the electronic display.

15. The method according to claim 12, the two or more distinct regions including at least an upper region of the electronic display and a lower region of the electronic display, the electronic display being defined by a plurality of discretely controllable pixels arranged as an array.
